(19) United States
(12) Patent Application Publication
(10) Pub. No.: US 2001/0013867 A1
(43) Pub. Date: Aug. 16, 2001

(54) OBJECT SEARCH METHOD AND OBJECT SEARCH SYSTEM

(76) Inventors: KENSHIU WATANABE, HITACHIOTA-SHI (JP); YUTAKA KANOU, FUJISAWA-SHI (JP)

Correspondence Address: OLIFF & BERRIDGE, P.O. BOX 19928, ALEXANDRIA, VA, 22320

(21) Appl. No.: 09/066,051

(22) Filed: Apr. 27, 1998

(51) Int. Cl. G06T 1/00; G06F 17/00; G06T 15/40; G06T 15/10; G06T 15/20

(52) U.S. Cl. 345/427; 345/421

(57) ABSTRACT

An object search method and an object search system which reduce the time needed for coordinate transformation of a plurality of objects to be displayed as three-dimensional view data through viewing transformation. The system determines a reference box which circumscribes a view volume, created according to an eyepoint. The system determines a bounding box for each object. Each bounding box circumscribes the corresponding object. A 6-d tree, composed of a plurality of nodes each having keys composed of the coordinate components of each bounding box, is prepared beforehand. With the coordinate components of the reference box as a search condition, the system searches the 6-d tree for bounding boxes included in the reference box. Then, the system performs coordinate transformation only on the objects corresponding to the obtained bounding boxes.

### BACKGROUND OF THE INVENTION

1. Field of the Invention

This invention relates to an object search method and an object search system, and more particularly to an object search method and an object search system for objects included in a view volume or display area.

2. Description of the Related Art

In computer graphics (CG), processing called clipping is performed. For example, when a distant view of a street is displayed on the screen, many objects such as buildings are shown. As the street is zoomed in, or comes into a visual field, the number of objects shown on the screen decreases. This visual field space is called a view volume. A process called clipping divides the objects into two sets: visible parts which are included in the view volume and invisible parts which are not, and then removes the invisible parts. This processing displays a smooth, natural image on the screen according to the eyepoint.

FIG. 1 is a diagram showing a conventional, general procedure for displaying a view volume, and FIG. 2 is a diagram showing the relationship between a view volume and objects. As shown in FIG. 1, a view volume is determined (S2) and object data is read out from a storage onto a main memory of a computer for processing (S4). Because these steps are independent, they may be executed in any order or in parallel. In the following description, the view volume determination step (S2) is explained first.

As shown in FIG. 2, a view volume 2 is determined by such factors as the position of an eyepoint O, a line-of-sight vector V, the position of a front clipping plane 4, the position of a back clipping plane 6, a horizontal visual field angle, and a vertical visual field angle. The determination of the view volume is similar to selecting a container in which an object is contained. In FIG. 2, viewing transformation is used to display a three-dimensional object on a two-dimensional screen. As a result, the view volume 2 is like a truncated pyramid with the eyepoint O at the original summit. Parallel transformation is another transformation method. Although effective for creating an orthographic views, the parallel transformation method cannot produce a picture with depth and therefore is not suitable for generating a natural view image dependent on the view point.

In a step separate from the determination of the view volume 2, object data is read out from the storage (S4) and coordinate transformation is performed on the data that is read (S6). This transformation is a linear projective transformation in which viewing projection is performed on the coordinates of the original objects. Viewing transformation, one of the known methods, is described in, for example, “Image and Space” (Koichiro Deguchi, ISBN-7856-2125-7, Chapter 5, Shokodo). Because it is unknown, at the time of coordinate transformation, which objects are included in the view volume 2, coordinate transformation is performed on all objects. FIG. 2 shows two objects, 8 and 10, after coordinate transformation.

Clipping is next performed (S8). In FIG. 2, the object 8 which is not included in the view volume 2 is removed while the object 10 which is included in the view volume 2 is not. After clipping is performed on all the objects in this manner, rastering is performed on the objects included, in whole or in part, in the view volume 2 (S10). Rasterizing, also called rendering in the world of CG, applies textures (patterns) or colors on the surfaces of objects and draws them. All these steps display right-sized objects at right places, thus giving users a natural view image.

However, the above method must perform coordinate transformation on all objects and processing therefore requires a long time. Applications such as a driving simulation or a flight simulation in which the eyepoint changes frequently require the computer to display the three-dimensional objects in a view volume in real time. Although computers continually become more and more powerful, there is a tendency for the speed required by CG applications to exceed the speed of the computer. The processing speed of the computer is one of the bottlenecks in three-dimensional CG processing.

Another problem is that a need to process various types of objects requires a large amount of memory. For example, a driving simulation in which an extensive area of a city is covered requires a huge number of objects. So is the walk-through view of a factory with complicated facilities. Therefore, three-dimensional simulation with all the objects on memory cannot be done in the conventional method when the amount of data is large.

### SUMMARY OF THE INVENTION

In view of the foregoing, it is an object of the present invention to provide a method and a system which search for three-dimensional objects included in a view volume quickly. It is another object of the present invention to provide a method and a system which searches for three-dimensional objects with a small amount of memory.

(1) In one form, the present invention comprises a first step of calculating a reference box based on a given view volume, a second step of calculating a bounding box of each object included in a three-dimensional search space, a third step of extracting one or more bounding boxes included in the reference box, and a fourth step of selecting one or more objects included in the view volume from the bounding boxes extracted in the third step.

The view volume is circumscribed by the reference box calculated in the first step. The reference box's height, width, and depth are parallel to the x, y, and z axis, respectively. The reference box is represented by a set of six numeric values: maximum (xsₘₐₓ) and minimum (xsₘᵢₙ) of the x coordinate values, maximum (ysₘₐₓ) and minimum (ysₘᵢₙ) of the y coordinate values, and maximum (zsₘₐₓ) and minimum (zsₘᵢₙ) of the z coordinate values.

An object is circumscribed by the corresponding bounding box calculated in the second step. The bounding box also has height, width, and depth, parallel to the x, y, and z axis, respectively. Like the reference box, each bounding box is represented by a set of six numeric values: maximum and minimum of the x, y, and z coordinate values. For example, the bounding box corresponding to the i-th (i is a natural number) object is represented as (xiₘₐₓ, xiₘᵢₙ, yiₘₐₓ, yiₘᵢₙ, ziₘₐₓ, ziₘᵢₙ).

In the third step, the bounding boxes included in the reference box are extracted. Here, “the bounding boxes included in the reference box” includes not only those completely included in the reference box, but also those partially included in the reference box (The same is true to the description below). In a preferred embodiment, a set of six numeric values representing the reference box are compared with a set of six numeric values representing a bounding box to determine if the bounding box is included in the reference box. This step is called rough clipping.

In the fourth step, a check is made to see whether or not the object corresponding to each bounding box extracted in the third step is included in the view volume (including the objects partially included in the view volume). The result is that only those objects included in the view volume are extracted. This step is called detailed clipping. In this step, coordinate transformation such as viewing transformation may be performed for the bounding boxes extracted in the third step and, based on the result of the coordinate transformation, a check is made to see whether or not the objects are included in the view volume.

The first to third steps of this method greatly reduce the number of objects whose coordinates are transformed in the fourth step. In addition, the calculation of the reference box and the bounding boxes, which is relatively straightforward and takes less time, greatly reduces the amount of calculation necessary for searching for objects included in the view volume. Therefore, this method allows the objects included in the view volume to be extracted and displayed in real time, even when the view point changes frequently.

(2) Another aspect of the present invention uses a tree such as a 6-d tree (6-dimensional tree). A 6-d tree is a k-d (k dimensional) tree where the number of keys (k) is 6, while a k-d tree is a binary tree used in a binary search where the number of search keys is k. This aspect extends the technique for using a k-d tree in searching for objects in the two-dimensional area so that the technique may be used in searching for objects in a three-dimensional area.

The 6-d tree used comprises a plurality of nodes each representing a bounding box corresponding to an object with six numeric values, such as above-described xiₘₐₓ, as its key. In the third step, a node (bounding box) satisfying a search condition, composed of six numeric values such as xsₘₐₓ, is extracted from this 6-d tree.

According to this aspect, in which the tree is created beforehand, an object satisfying the search condition may be found quickly. In addition, the tree composed of a plurality of nodes each containing only six numeric values takes up less space for memory. This reduces the amount of memory required for a sequence of processing.

(3) Another method according to the present invention comprises a first step of dividing a view volume into a plurality of parts along a line-of-sight, a second step of finding a sub-reference box for each part obtained in the first step, a third step of calculating a bounding box of each object included in a search space, a fourth step of extracting one or more bounding boxes included in one of the sub-reference boxes, and a fifth step of selecting a plurality of objects corresponding to the bounding boxes extracted in the fourth step and, extracting the objects included in the view volume from the selected objects.

Each part of the view volume is circumscribed by the corresponding sub-reference box calculated in the second step, the sub-reference box having a height, a width, and a depth, parallel to the x, y, and z axis, respectively. These sub-reference boxes are arranged along the line-of-sight. Each object is circumscribed by the corresponding bounding box having a height, a width, and a depth, parallel to the x, y, and z axis, respectively.

In this method, the total volume of the sub-reference boxes is less than the volume of the reference box calculated in the method described in (1), meaning that the amount of wasteful search is reduced.

(4) In one form of this method, the bounding boxes are extracted from the sub-reference boxes in a sequential order with the sub-reference box nearest to the eyepoint first.

In many cases, the objects near the eyepoint are important. This method allows the objects near the eyepoint to be rendered first.

(5) A system according to the present invention may also be comprised of parameter accepting means for accepting parameters specifying the view volume; reference box calculating means for calculating a reference box based on the parameters accepted by the parameter accepting means; storage means for storing definition data on each object; bounding box calculating means for calculating, based on the definition data on each object stored in the storage means, a bounding box of each object; first clipping means for extracting one or more bounding boxes included in the reference box; and second clipping means for selecting a plurality of objects from the bounding boxes extracted by the first clipping means and, extracting objects included in the view volume from the selected objects.

### BRIEF DESCRIPTION OF THE DRAWINGS

FIG. 1 is a diagram showing a typical conventional procedure for displaying objects in a view volume.

FIG. 2 is a diagram showing a relation between a view volume and objects.

FIG. 3 is a diagram showing the configuration of a space search system of an embodiment according to the present invention.

FIG. 4 is a diagram showing an example of a 1-d tree.

FIG. 5 is a diagram showing an example of a 2-d tree.

FIG. 6 is a diagram showing a relation between the 2-d tree and a two-dimensional area.

FIG. 7 is a diagram showing a relation between the 2-d tree and the two-dimensional area.

FIG. 8 is a diagram showing a relation between the 2-d tree and the two-dimensional area.

FIG. 9 is a flowchart showing an operating procedure for the space search system used in the embodiment.

FIG. 10 is a diagram showing a reference box.

FIG. 11 is a diagram showing a bounding box.

FIG. 12 is a diagram showing the view volume divided into two parts each circumscribed by a sub-reference box.

### DESCRIPTION OF THE PREFERRED EMBODIMENT

An embodiment of a space search system according to the present invention will be described with reference to the attached drawings.

[1] System configuration

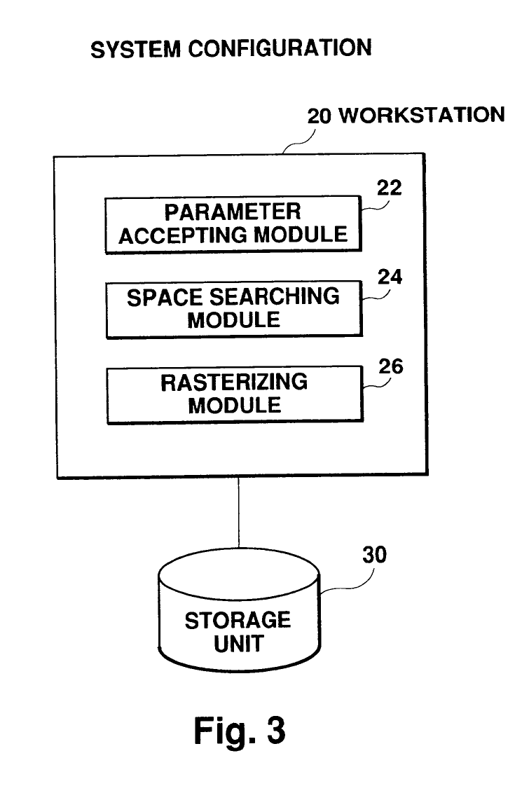

FIG. 3 is a diagram showing the configuration of an object search system used in the embodiment. This object search system maybe implemented by a standalone workstation. The embodiment of this invention, capable of fast object search, allows even a standard workstation to search for and display data in real time.

As shown in the figure, the system comprises a workstation 20 and a storage unit 30. The storage unit 30 contains the 6-d tree of, and the coordinate data on, the objects.

The workstation 20 has a parameter accepting module 22 which accepts user input specifying an area to be rendered. This area to be rendered is treated as a view volume. The system requests the user to enter view volume specification parameters such as the eyepoint parameter. Entered view volume specification parameters are sent to a space searching module 24. Upon receiving the parameters, the space searching module 24 performs clipping by referencing the object data stored in the storage unit 30 . Space search results are sent to a rasterizing module 26.

The rasterizing module 26 reads data on the necessary objects based on the space search results, performs rasterization which is a known technique, and displays the rasterized objects on the screen.

[2] 6-d Tree

The 6-d tree is prepared in the storage unit 30 before space search starts. The following explains the concept of trees in order of a 1-d tree, a 2-d tree, and a 6-d tree. A technique for using a k-d (k dimensional) tree for a plane search is described in “Multidimensional binary search trees used for associative searching” by J. L. Bentley, Communication of the ACM, vol.18, No.9, 509-517 1975 or in “Geographical data structures compared: A study of data structures supporting region queries” by J. B. Rosenberg, IEEE Trans. on CAD, Vol. CAD-4, No. 1, 53-67, Jan. 1985. This embodiment extends the technique described in those papers into a space search.

(1) 1-d Tree

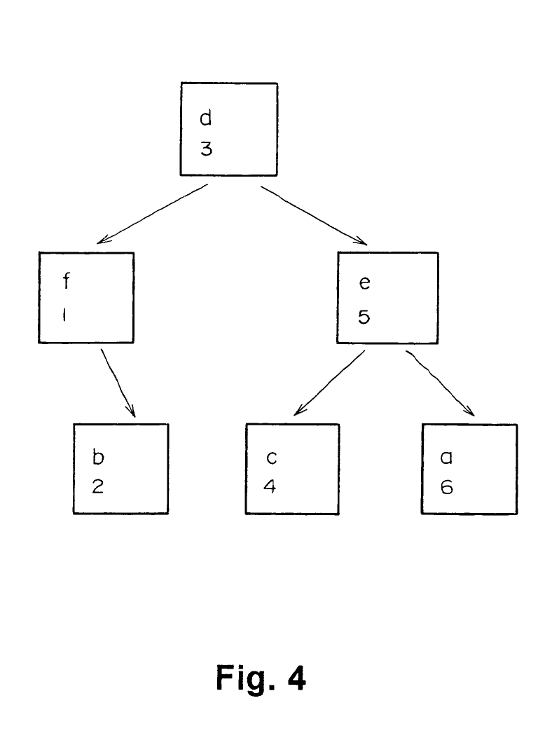

A 1-d tree is a simple binary tree. FIG. 4 shows an example of a 1-d tree. As shown in the figure, the tree has six nodes, a to f, each having its own key (numeric data). The root is node d, the children (represented as chd) of the root are nodes f and e, and leaves are nodes b, c, and a. The rule for generating a 1-d tree is as follows:

Rule 1. For any node x,

K(x)≧K (ptree; root=left_chd (x))

Rule 2. For any node x,

K(x)<K (ptree; root=right_chd (x))

where, K is a key, and K(i) is the key of node i. “ptree; root=left_chd (x)” and “ptree; root=right_chd (x)” are any nodes included in the subtree “ptree” whose root is the left child node of x or the right child node of x respectively.

In this 1-d tree, a region search is possible. For example, if we are given the following condition,

Condition: K<3

then, nodes f and b satisfy the condition. To find these two nodes, a check is first made to see if the root, node d, satisfies the above condition. Because the key of node d, 3, exceeds the upper bound of the condition, there is no need to check the nodes in the subtree whose root is the right child of the node d. Thus, once a search condition and key relations are given, a desired node can be found quickly.

(2) 2-d Tree

A 2-d tree allows desired nodes to be found quickly when conditions are given to two keys. These two keys, independent of each other, must be included in one tree.

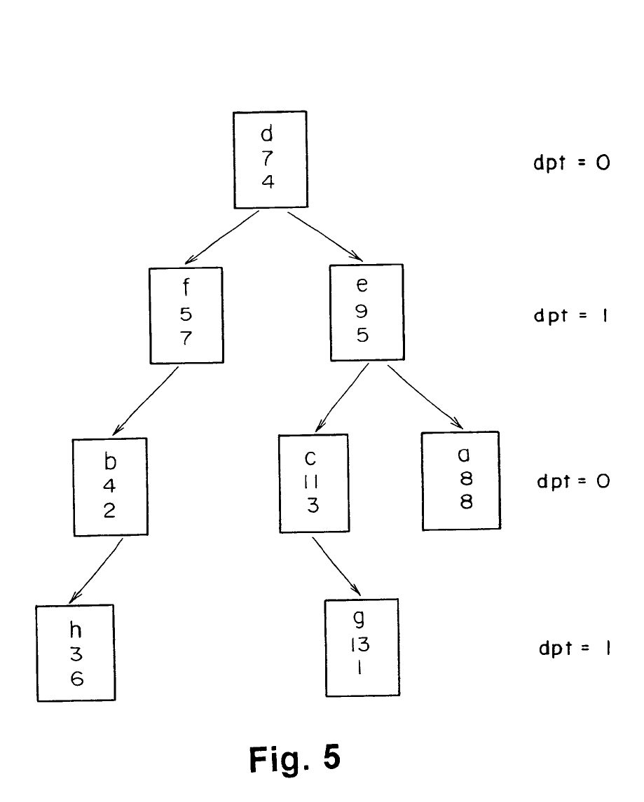

FIG. 5 shows an example of a 2-d tree in which there are eight nodes, a to h, each having two keys. For convenience, the top key is called “the 0th key”, and the bottom key “the 1st key”. The depth of node d (represented as D) at the root level is defined as 0, the depth of nodes and e at the second level is defined as 1, and so on, with the depth of level n being (n−1). An indicator “dpt” is defined as follows:

dpt=D mod k

Because k, the number of keys, is 2, dpt is a repetition of 0 and 1. Rules for generating this tree is as follows:

Rule 1 For the dpt-th key K(x, dpt) in any node x,

K(x, dpt)≧K (ptree ; root=left_chd (x), dpt)

Rule 2 For the dpt-th key K(x, dpt) at node x,

K(x, dpt)<K (ptree ; root=right_chd (x), dpt)

These rules are explained with reference to FIG. 5. For node d at the root, dpt=0. Hence, rules 1 and 2 are rewritten as follows.

Rule 1. The 0th key of node d is

equal to or greater than the 0th key of any node in the subtree whose root is node f which is the left child of node d. In FIG. 5, this is true because “7” (node d) is greater than “5” (node f), “4” (node b), and “3” (node h).

Rule 2. The 0th key of node d is

less than 0th key of any node in the subtree whose root is node e which is the right child of node d. In the figure, this is true because “7” is less than “9”, “11”, “8”, and “13”.

Hence, node d and the subordinates nodes are related by the 0th key.

Next, consider node e. Because dpt=1 for node e, rules 1 and 2 are rewritten as follows:

Rule 1. The 1st key of node e is equal to or greater than the 1st key of any node in the subtree whose root is node c which is the left child of node e. In the figure, this is true because “5” is greater than “3” and “1”.

Rule 2. The 1st key of node e is less than the 1st key of any node in the subtree whose root is node a which is the right child of node e. In the figure, this is true because “5” is less than “8”.

Hence, node e and the subordinates nodes are related by the 1st key. Thus, a node with dpt=0 and the subordinate nodes of the node are related by the 0th key, and a node with dpt=1 and the subordinate nodes of the node by are related by the 1st key. A 2-d tree, which has two keys, may be treated like the binary tree described in (1) once a node is selected.

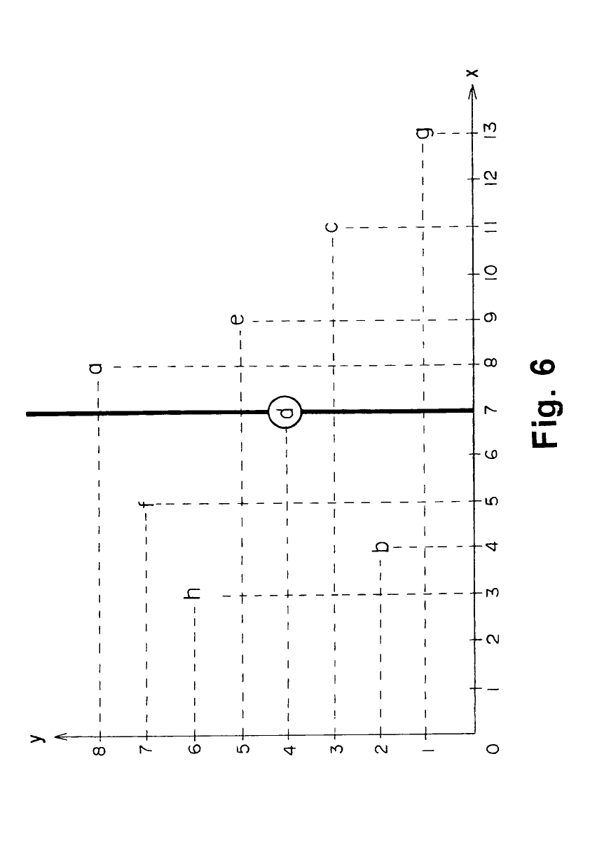

FIGS. 6 to 8 show the relationship between the 2-d tree and the two-dimensional region. In this figure, the x-axis is in the direction of the 0th key and the y-axis is in the direction of the 1st key. First, as shown in FIG. 6, the region is divided into two by node d (X=7). A node below node d belongs to one of two regions.

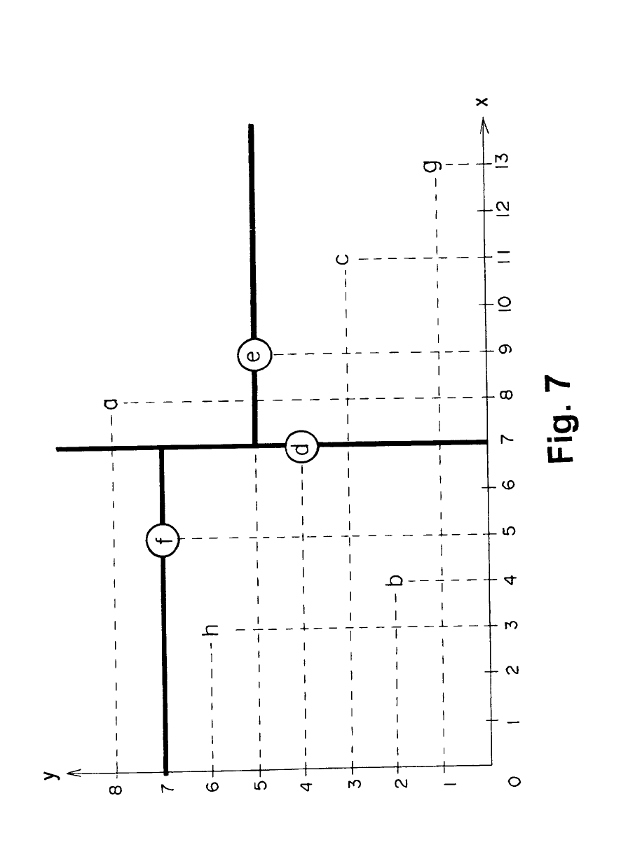

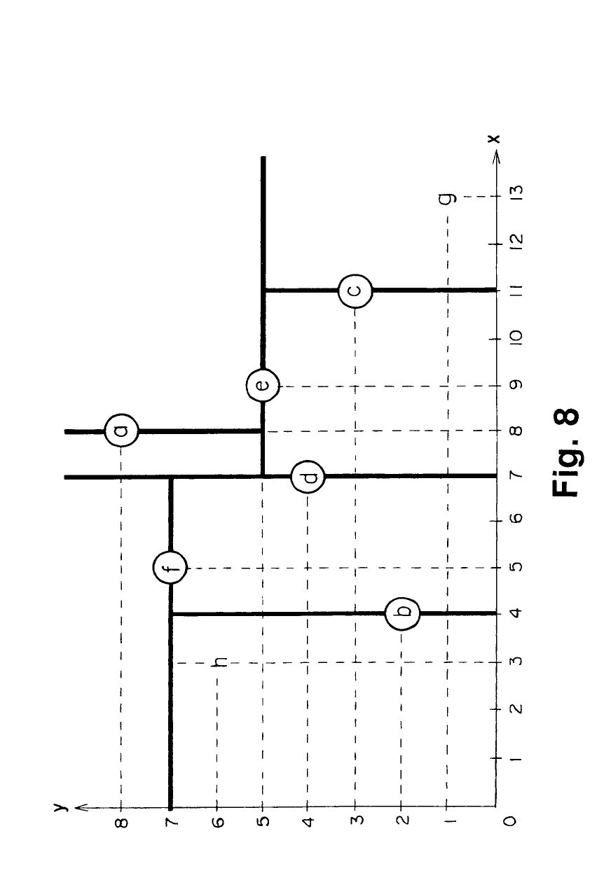

Next, as shown in FIG. 7, each region is divided into two by nodes f (y=7) and node e (y=5). In FIG. 8, each region is further divided by nodes b (x=4), c (x=11) and a (x=8). Therefore, it is apparent that a new node with any key belongs to one of two-dimensional regions shown in FIG. 6 and other figures, meaning that the node may be connected to the 2-d tree as a leaf. That is, a node finds its place in the tree no matter which node is selected as the root.

A 2-d tree generated as described above makes enables us to make a two-key region search. For example, suppose that the following two search conditions are given:

Condition 0: 0th key>7

Condition 1: 1st key>6

Under these conditions, only node a is selected.

In the selection process, first, a check is made to see if node d, the root, satisfies condition 0. Because the 0th key of node d(=7) does not satisfy the lower bound, it is determined that node f (the left child of node d) and the subordinate nodes do not satisfy the condition.

On the other hand, a check is made to see whether or not node e, which satisfies condition 0, satisfies condition 1. Because the 1st key of node e(=5) does not satisfy the lower bound of condition 1, it is determined that node c (the left child of node e) and the subordinate nodes do not satisfy the condition. A repetition of this check efficiently narrows down candidate nodes.

(3) 6-d tree

A 2-d tree allows us to make a two-key search, meaning that we can search for a point in a desired region in the x-y plane. Similarly, the use of four keys, described as Xₘᵢₙ, Xₘₐₓ, Yₘᵢₙ, Yₘₐₓ, allows us to define the nodes as a rectangular region in the x-y plane.

A 6-d tree has six keys. In this embodiment, these keys are assigned to the values, Xiₘₐₓ, . . . , of object i. That is, the 0th key to the 5th key are assigned to Xiₘᵢₙ, Yiₘᵢₙ, Ziₘᵢₙ, Xiₘₐₓ, Yiₘₐₓ, Ziₘₐₓ. The tree generation rules, not shown, are the same as those for a 2-d tree, except that k is 6 in the following depth calculation formula:

dpt=D mod k

A node in a 6-d tree thus generated may be defined as a region with a volume in the x-y-z space; that is it may be defined as a box, or a rectangular parallelepiped. In a 6-d tree used in this embodiment, a node represents a bounding box (described later) corresponding to an object with six numeric values, such as Xiₘₐₓ, being the keys of the node. In this embodiment, the system performs clipping using this 6-d tree under the search condition specified by six numeric values of a reference box which will be described later.

[3] System operation

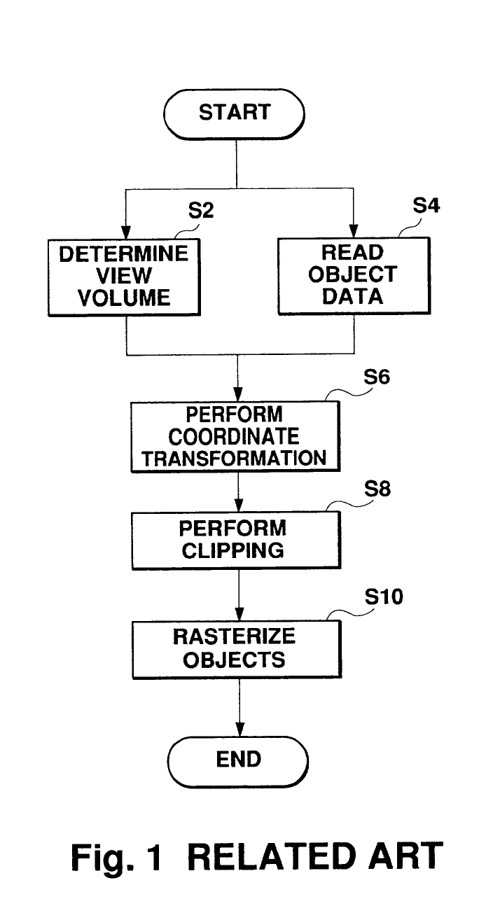

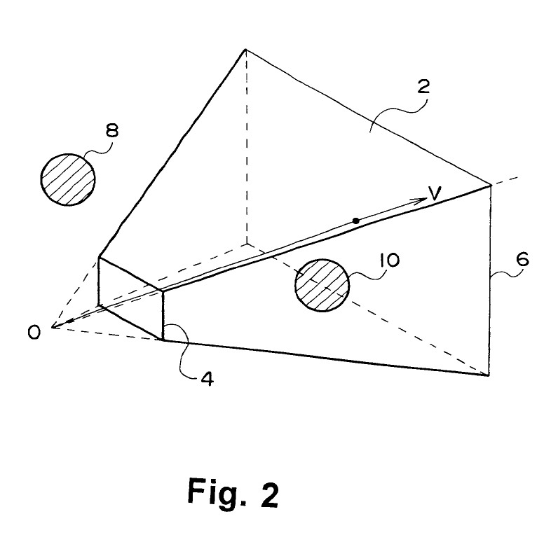

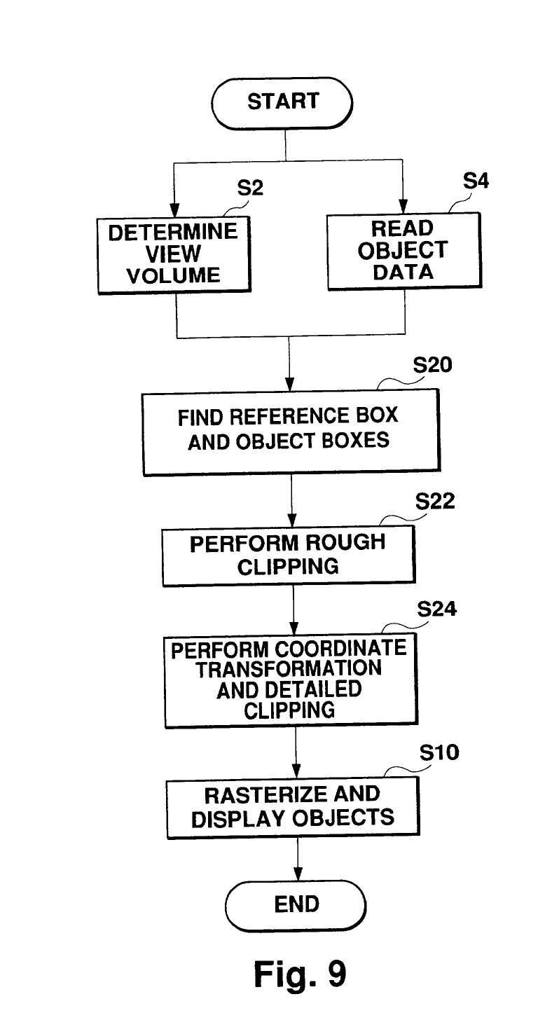

FIG. 9 is a flowchart showing the operating procedure of a space search system used in this embodiment. In FIG. 9, the same symbols as used in FIG. 1 are assigned to corresponding processes. Before starting operation, it is assumed that the 6-d tree of object data is stored in the storage unit 30 and the object data itself is stored in the storage unit 30.

As shown in FIG. 9, the system first prompts a user to specify a view volume (S2). The parameter accepting module 22 accepts user-specified parameters for transmission to the space searching module 24. At the same time, object data on the objects is read from the storage unit 30 to main memory of workstation 20 (S4).

Then, the space searching module 24 finds the reference box of the view volume and the bounding box of each object (S20).

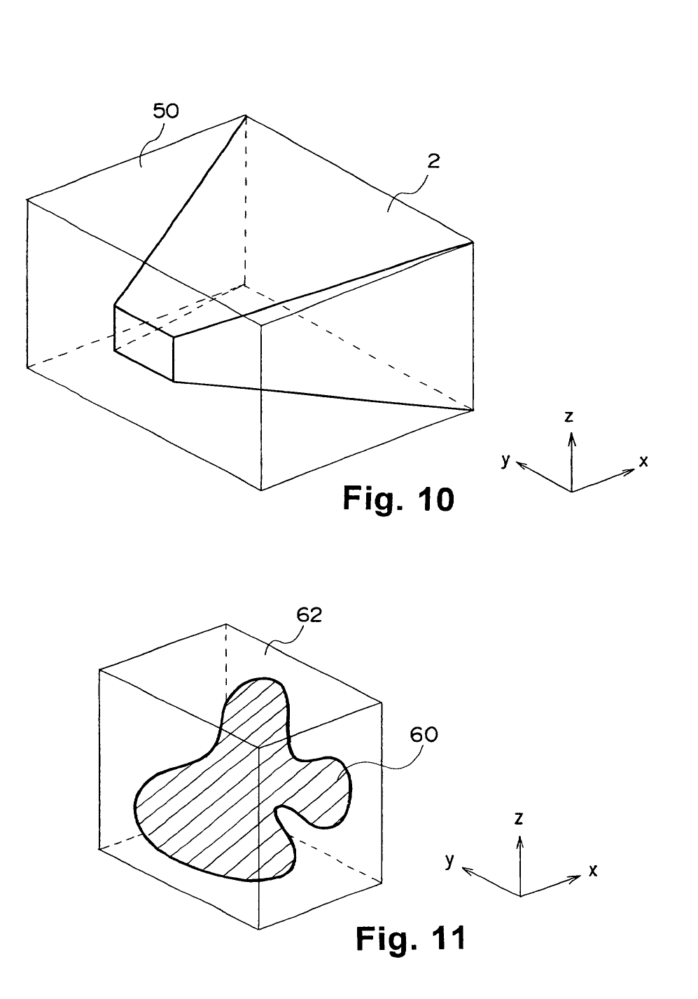

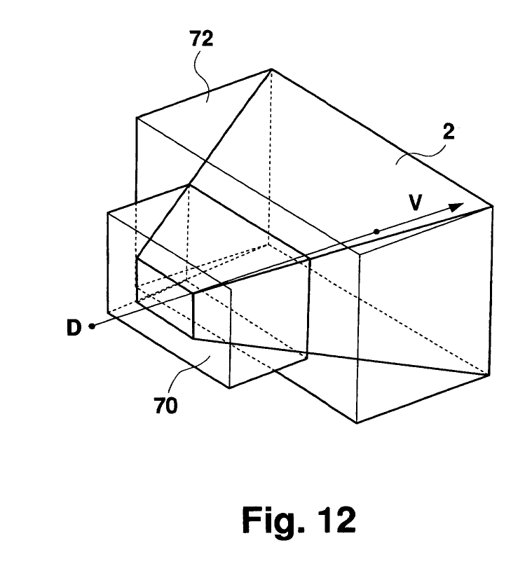

FIG. 10 shows a reference box, and FIG. 11 shows a bounding box. As shown in FIG. 10, the reference box circumscribes the view volume 2. The two faces out of the six faces of the reference box are determined by the front clipping face and the back clipping face, with the remaining four automatically determined by these two faces. On the other hand, the bounding box 62 circumscribes the object 60 as shown in FIG. 11, with the sides of the bounding box parallel to the sides of the reference box. The object 60, which is usually much smaller than the view volume 2, is magnified in the figure.

The reference box that is found is represented by a set of six numeric values (xsₘₐₓ, xsₘᵢₙ, ysₘₐₓ, ysₘᵢₙ, zsₘₐₓ, zsₘᵢₙ) from the box's eight vertexes, where xsₘₐₓ and xsₘᵢₙ are the maximum x-coordinate and the minimum x-coordinate, ysₘₐₓ and ysₘᵢₙ are the maximum y-coordinate and the minimum y-coordinate, and zsₘₐₓ and zsₘᵢₙ are the maximum z-coordinate and the minimum z-coordinate. Similarly, the bounding box of each object is represented by a set of six numeric values: maximum x-coordinate and minimum x-coordinate, maximum y-coordinate and minimum y-coordinate, and maximum z-coordinate and minimum z-coordinate. That is, the bounding box of the i-th (“i” is a natural number) is represented by (xiₘₐₓ, xiₘᵢₙ, yiₘₐₓ, yiₘᵢₙ, ziₘₐₓ, ziₘᵢₙ).

Next, the space searching module 24 performs rough clipping (S22). This rough clipping extracts only the bounding boxes included in the reference box. Whether or not a bounding box is included in the reference box is determined by comparing the set of six numeric values representing the reference box and the six numeric values representing the bounding box. In this embodiment, this comparison is made by making a conditional search in the 6-d tree. For example, the search conditions for a bounding box to be completely included in the reference box are the following six conditions:

Condition 0: the 0th key xiₘᵢₙ≧xsₘᵢₙ

Condition 1: the 1st key yiₘᵢₙ≧ysₘᵢₙ

Condition 2: the 2nd key ziₘᵢₙ÷zsₘᵢₙ

Condition 3: the 3rd key xiₘₐₓ≦zsₘₐₓ

Condition 4: the 4th key yiₘₐₓ≦ysₘₐₓ

Condition 5: the 5th key ziₘₐₓ≦zsₘₐₓ

Rough clipping is performed to reduce the amount of calculation for detailed clipping. In this stage, an object which may be at least partly visible is selected at this time. That is, a bounding box is extracted if it is included either completely or partly in the reference box. For example, a search for a bounding box whose y-axis and z-axis coordinate values are completely included in the respective ranges of y and z coordinates of the reference box but whose x-axis coordinate values are not completely included in the range of x coordinate of the reference box may be made by changing only condition 0 to

Condition 0: the 0th key xiₘᵢₙ<xsₘᵢₙ

or by changing only condition 3 to

Condition 3: the 3rd key xiₘₐₓ>xsₘₐₓ.

Considering a bounding box partly sticking out of y-axis or z-axis directions, a search for a bounding box partly sticking out of the reference box only in one direction (x, y, or z) may be made by not referencing one of conditions 0 to 5.

Similarly, a search for bounding boxes partly sticking out of the reference box in two directions (x and y, y and z, or z and x) may be made as follows:

(Condition 0 or 3 not referenced)×(Condition 1 or 4 not referenced)+(Condition 0 or 3 not referenced)×(Condition 2 or 5 not referenced) +(Condition 1 or 4 not referenced)×(Condition 2 or not referenced)

Where operator “×” indicates the logical AND, while operator “+” indicates the logical OR. A search for bounding boxes partly sticking out of the reference box in three directions may be made by

(Condition 0 or 3 not referenced)×(Condition 1 or 4 not referenced)×(Condition 2 or 5 not referenced).

In summary, the combinations of conditions to be used to search for a bounding box which is at least partly contained in the reference box are:

(Condition 0 or 3)×(Condition 1 or 4)×(Condition 2 or 5) (1)

The logical expression (1) can be expanded in 8 combinations of conditions. For each of these eight combinations, bounding boxes that may be included in the reference box are selected according to the procedure for the 6-d tree.

For rough clipping, it should be noted that there is a bounding box with a side longer than that of the reference box. For example, for a very high building, the z-axis direction of the reference box are sometimes exceeded. In such a special case, conditions 2 and 5 are as follows:

Condition 2: the 2nd key ziₘₐₓ<zsₘᵢₙ

Condition 5: the 5th key ziₘₐₓ>zsₘₐₓ

If both conditions are satisfied at the same time (condition 6), then (condition 2 or 5) in expression (1) should be changed to (condition 2 or 5 or 6). This applies also in the x and y directions. Rough clipping is achieved using this search process.

Next, the space searching module 24 transforms the coordinates (e.g., viewing transformation) of the objects selected by rough clipping and performs detailed clipping (S24). Because objects are selected in the rough clipping stage, the amount of calculation for coordinate transformation is significantly reduced. In the detailed clipping stage, only the objects included in the view volume are selected from those selected in S22 by known techniques. Results of detailed clipping are sent to the rasterizing module 26. Upon receiving the results, the rasterizing module 26 reads out data only on the objects to be rendered from the storage unit 30, rasterizes the objects, and then displays the rasterized objects on the screen (S10).

The system operates as described above. The system reduces the time needed for coordinate transformation that took the conventional system a very long time, making it possible to build a real-time three-dimensional system. The 6-d tree prepared beforehand allows necessary object data to be identified quickly. In addition, the straightforward calculation process described above requires less amount of work area memory.

The embodiment has the following variations:

(1) It is understood from FIG. 10 that there is no need to make a search in the space which is in the reference box 50, but outside the view volume. In general, the larger the visual field angle, the larger the wasted space. To reduce this wasted space, the view volume is divided into a plurality of parts along the line-of-sight such that a plurality of sub-reference boxes, each circumscribing one of the plurality of parts, cover the view volume. In FIG. 12, the view volume 2, divided into two parts along the line-of-perspective, is covered by two sub-reference boxes: the sub-reference box 70 which circumscribes the part near the eyepoint O and the sub-reference box 72 which circumscribes the part distant from the eyepoint O.

For each sub-reference box thus created, rough clipping is performed (S22) and a bounding box contained in any of the sub-reference boxes is selected. The total volume of the sub-reference box 70 and the sub-reference box 72 is less than the volume of the reference box 50 shown in FIG. 10, meaning that the amount of wasteful search is reduced. This method is recommenced for use in a system where the visual field angle is large because it more powerful as the visual field angle becomes larger.

(2) When using sub-reference boxes, space search may be made in the sequential order with the sub-reference box nearest to the eyepoint first. In FIG. 12, rough clipping is first performed (S22) for the smaller sub-reference box 70. Necessary coordinate transformation (detailed clipping) and rasterization are then performed based on the results of the rough clipping. In parallel with the coordinate transformation for the smaller box 70, rough clipping is performed (S22) for the larger sub-reference box 72. Then, based on these results, necessary detailed clipping and rasterization are performed. This method thereby allows processing for a plurality of sub-reference boxes to be executed in parallel, making it easier to build a real-time processing system. Another advantage is that the objects near the eyepoint, which are important, are rendered first.

(3) In this embodiment, the 6-d tree is stored in the storage unit 30. The 6-d tree, which is referenced frequently during the search, may be loaded into memory in advance.

While there has been described what is at present considered to be the preferred embodiment of the invention, it will be understood that various modifications may be made thereto, and it is intended that the appended claims cover all such modifications as fall within the true spirit and scope of the invention.

What is claimed is:

1. A method for extracting objects included in a view volume, comprising:
a first step of calculating a reference box, the view volume being circumscribed by the reference box, whose height, width, and depth is parallel to the x, y, and z axis, respectively;
a second step of calculating a bounding box of each object included in a search space, the object being circumscribed by the corresponding bounding box, whose height, width, and depth is parallel to the x, y, and z axis, respectively;
a third step of extracting one or more bounding boxes included in the reference box from bounding boxes obtained in the second step; and
a fourth step of selecting one or more objects corresponding to the bounding boxes extracted in the third step, and extracting one or more objects included in the view volume from the selected objects.

2. A method according to claim 1, further comprising a fifth step of displaying the objects extracted in the fourth step.

3. A method according to claim 1, wherein the third step comprises a step of comparing the maximum and minimum values of the x, y, and z coordinates of the bounding box with the maximum and minimum values of x, y, and z coordinates of the reference box in order to extract the bounding boxes included in the reference box.

4. A method according to claim 1, wherein the third step comprises additional steps of;
creating a 6-d tree composed of a plurality of nodes, each node of the 6-d tree corresponding to each bounding box and having six numeric keys composed of the maximum and minimum values of the x, y, and z coordinates of the corresponding bounding box; and
searching the 6-d tree for one or more nodes satisfying a search condition, the search condition being the six numeric values representing the maximum and minimum values of the x, y, and z coordinates of the reference box.

5. A method for extracting objects included in a view volume, comprising:
a first step of dividing the view volume into a plurality of parts along a line-of-sight;
a second step of calculating a sub-reference box for each part obtained in the first step, each part being circumscribed by the corresponding sub-reference box whose height, width, and depth are parallel to the x, y, and z axis, respectively;
a third step of calculating a bounding box of each object included in a search space, each object being circumscribed by the corresponding bounding box whose height, width, and depth are parallel to the x, y, and z axis, respectively;
a fourth step of extracting one or more bounding boxes included in one of the reference boxes from bounding boxes obtained in the third step; and
a fifth step of selecting one or more objects corresponding to the bounding boxes extracted in the fourth step and, from the selected objects, and extracting one or more objects included in the view volume from the selected objects.

6. A method according to claim 5, further comprising a sixth step of displaying the objects extracted in the fifth step.

7. A method according to claim 5, wherein the fourth step comprises steps of;
extracting one or more objects included in each sub-reference box in a sequential order with the sub-reference box nearest to the eyepoint first; and
executing the fifth step and sixth step for the bounding boxes included in each sub-reference box.

8. A method according to claim 5, wherein the fourth step comprises a step of comparing the maximum and minimum values of the x, y, and z coordinates of the bounding box with the maximum and minimum values of x, y, and z coordinates of the sub-reference box in order to extract the bounding boxes included in the sub-reference box.

9. A method according to claim 5, wherein the fourth step comprises steps of;
creating a 6-d tree composed of a plurality of nodes, each node of the 6-d tree corresponding to each bounding box and having six numeric keys composed of the maximum and minimum values of the x, y, and z coordinates of the corresponding bounding box; and
searching the 6-d tree for one or more node satisfying a search condition, the search condition being the six numeric values representing the maximum and minimum values of the x, y, and z coordinates of the reference box.

10. A system for extracting objects included in a view volume, comprising:
parameter accepting means for accepting parameters specifying the view volume;
reference box calculating means for calculating a reference box based on the parameters accepted by the parameter accepting means, the view volume being circumscribed by the reference box whose height, width, and depth are parallel to the x, y, and z axis, respectively;
storage means for storing definition data on each object;
bounding box calculating means for calculating a bounding box for each object based on the definition data on each object stored in the storage means, each object being circumscribed by the corresponding bounding box, having the height, width, and depth of each bounding box being parallel to the x, y, and z axis, respectively;
first clipping means for extracting one or more bounding boxes included in the reference box from bounding boxes obtained by the bounding box calculating means; and
second clipping means for selecting one or more objects corresponding to the bounding boxes extracted by the first clipping means and, extracting objects included in the view volume from the selected objects.

11. A system according to claim 10, further comprising means for displaying the objects extracted by the second clipping means.

12. A system according to claim 10, wherein the first clipping means compare the maximum and minimum values of the x, y, and z coordinates of the bounding box with the maximum and minimum values of x, y, and z coordinates of the reference box in order to extract the bounding boxes included in the reference box.

13. A system according to claim 10, wherein the first clipping means create a 6-d tree composed of a plurality of nodes, each node of the 6-d tree corresponding to each bounding box and having six numeric keys composed of the maximum and minimum values of the x, y, and z coordinates of the corresponding bounding box, and search the 6-d tree for one or more nodes satisfying a search condition, the search condition being the six numeric values representing the maximum and minimum values of the x, y, and z coordinates of the reference box.
